(19) United States
(12) Patent Application Publication
(10) Pub. No.: US 2023/0052111 A1
(43) Pub. Date: Feb. 16, 2023

(54) SPEECH ENHANCEMENT APPARATUS, LEARNING APPARATUS, METHOD AND PROGRAM THEREOF

(71) Applicant: NIPPON TELEGRAPH AND TELEPHONE CORPORATION, Tokyo (JP)

(72) Inventor: Yuma KOIZUMI, Tokyo (JP)

(73) Assignee: NIPPON TELEGRAPH AND TELEPHONE CORPORATION, Tokyo (JP)

(21) Appl. No.: 17/793,006

(22) PCT Filed: Jan. 16, 2020
(86) PCT No.: PCT/JP2020/001356

§ 371 Date: Jul. 14, 2022

(51) Int. Cl. G10L 21/0264; G10L 17/04

(52) U.S. Cl. CPC G10L 21/0264; G10L 17/04

(57) ABSTRACT

A mask to enhance speech emitted from a speaker is estimated from an observation signal, the mask is applied to the observation signal, and thereby a post-mask speech signal is acquired. The mask is estimated from a feature obtained by combining a feature for speaker recognition extracted from the observation signal and a feature for generalized mask estimation extracted from the observation signal.

### TECHNICAL FIELD

The present disclosure relates to a speech enhancement technology.

### BACKGROUND ART

As a representative technique for speech enhancement using deep learning, there is a method of estimating a time-frequency (T-F) mask using a deep neural network (DNN) (DNN speech enhancement). This is a method in which an observation signal obtained by expressing an observation signal in a time-frequency domain using a short-time Fourier transform (STFT), or the like is obtained, the observation signal is multiplied by a time-frequency mask estimated using the DNN, and the result undergoes an inverse STFT to obtain enhanced sound (see, for example, NPL 1 to NPL 5, etc.).

There is “generalization performance” as an important functional requirement to achieve DNN speech enhancement. This is a performance that enables speech to be enhanced irrespective of the type of speaker uttering the speech (e.g., known or unknown, a male or a female, or an infant or an elderly speaker). To accomplish this performance, in DNN speech enhancement of the related art, it has been thought right to train one DNN using a large amount of data of speech uttered by a large number of speakers to train a speaker-independent model.

Meanwhile, in other speech applications, the attempt to “specialize” a model has been successful. In other words, this is a method of training a high-performance DNN only for a particular speaker. An exemplary method to accomplish this is “model adaptation”.

### CITATION LIST

### Non Patent Literature

NPL 1: C. Valentini-Botinho, X. Wang, S. Takaki, and J. Yamagishi, “Investigating RNN-based Speech Enhancement methods for Noise-Robust Text-to-Speech”, Proc. of 9th ISCA Speech Synth. Workshop (SSW), 2016.
NPL 2: S. Pascual, A. Bonafonte, and J. Serra, “SEGAN: Speech Enhancement Generative Adversarial Network”, Proc. of Interspeech, 2017.
NPL 3: M. H. Soni, N. Shah, H. A. Patil, “Time-Frequency Masking-Based Speech Enhancement Using Generative Adversarial Network”, Proc. of Int. Conf. on Acoust., Speech, and Signal Process (ICASSP), 2018.
NPL 4: F. G. Germain, Q. Chen, and V. Koltun, “Speech Denoising with Deep Feature Losses”, arXiv preprint, arXiv: 1806.10522, 2018.
NPL 5: S. W. Fu, C. F. Liao, Y. Tsao, and S. D. Lin, “MetricGAN: Generative Adversarial Networks based Black-box Metric Scores Optimization for Speech Enhancement”, Proc. of Int. Conf. on Machine Learning (ICML), 2019.

### SUMMARY OF THE INVENTION

### Technical Problem

However, the method of “specializing” a model of the related art has the problem that the method uses an auxiliary utterance of a desired speaker (target speaker) whose speech is attempted to be enhanced.

The present disclosure has been made in view of this point and aims to perform speech enhancement specialized to a target speaker without using an auxiliary utterance of the target speaker whose speech is attempted to be enhanced.

### Means for Solving the Problem

A mask to enhance speech emitted from a speaker is estimated from an observation signal, the mask is applied to the observation signal, and thereby a post-mask speech signal is acquired. The mask is estimated from a feature obtained by combining a feature for speaker recognition extracted from the observation signal and a feature for generalized mask estimation extracted from the observation signal.

### Effects of the Invention

As described above, according to the present disclosure, speech enhancement specialized to a target speaker can be performed without using an auxiliary utterance of the target speaker whose speech is attempted to be enhanced.

### BRIEF DESCRIPTION OF DRAWINGS

FIG. 1 is a block diagram illustrating a functional configuration of a training apparatus according to an embodiment.

FIG. 2 is a block diagram illustrating a functional configuration of a speech enhancement apparatus according to the embodiment.

FIG. 3 is a flow diagram illustrating a training method according to the embodiment.

FIG. 4 is a flow diagram illustrating a speech enhancement method according to the embodiment.

FIG. 5 is a block diagram for describing a hardware configuration.

### DESCRIPTION OF EMBODIMENTS

Hereinafter, an embodiment of the present disclosure will be described with reference to the drawings.

### Principle

First, the principle will be described.

### DNN Speech Enhancement

Problem setting: It is assumed that an observation signal x ϵ R^{T} in the time range of T samples is a mixed signal of a target speech signal s and a noise signal n, which is x=s+n. The purpose of speech enhancement is to estimate s from x with high accuracy. As illustrated in equation (1), a speech enhancement apparatus based on DNN speech enhancement obtains an observation signal X=Q(x) ϵ C^{F×K} in which the observation signal x is expressed in the time-frequency domain through frequency domain conversion processing Q: R^{T}->R^{F×K} such as a short-time Fourier transform, obtains a post-mask speech signal M(x; θ)⊚Q(x) by multiplying X by a time-frequency (T-F) mask M estimated using the DNN, and obtains enhanced speech y by further applying time domain conversion processing Q⁺ such as an inverse STFT to the post-mask speech signal M(x; θ)⊚Q(x).

y=Q⁺(M(x;θ)⊚Q(x)) (1)

Here R represents a set of all real numbers, and C represents a set of all complex numbers. T, F, and K represent positive integers, and T represents the number of observation signals x (time length) belonging to a predetermined time interval. F represents the number of discrete frequencies (bandwidth) belonging to a predetermined band of the time-frequency domain. K represents the number of discrete times (time length) belonging to a predetermined time interval in the time-frequency domain. M(x; θ)⊚Q(x) represents multiplying Q(x) by the T-F mask M(x; θ). θ is a parameter of the DNN, and is typically trained, for example, to minimize a signal-to-distortion ratio (SDR)L^{SDR} expressed by the following equation (2).

L^{SDR}=−(clipβ[SDR(s,y)]+clipβ[SDR(n,m)])/2 (2)

Where

SDR(s,y)=10 log₁₀(∥s∥₂²/∥s−y∥₂²) [Math.1]

and

∥·∥₂ [Math.2]

is L₂ norm, m=x−y, clipβ[x]=β· tanh (x/β), and
β>0 is a clipping constant. For example, β is equal to 20.

“Generalization” and “Specialization” in DNN Speech Enhancement Point: There is a “generalization performance” that is an important functional requirement for achieving DNN speech enhancement. This is a performance that enables speech to be enhanced irrespective of the type of speaker uttering the speech. To accomplish this performance, in the DNN speech enhancement of the related art it has been premised that one DNN is trained using a large amount of data of speech uttered by a large number of speakers to train a speaker-independent model.

Meanwhile, in other speech applications, the attempt to “specialize” a model has been successful. In other words, this is a method of training a high-performance DNN only for a particular speaker. An exemplary method to accomplish this is “model adaptation”.

In the present embodiment, the concept of speaker adaptation is incorporated into the DNN speech enhancement to achieve high accuracy. In this case, DNN speech enhancement specialized to a real speaker (target speaker) that uses no auxiliary utterance is achieved by introducing multi-task learning on speaker recognition. In the present embodiment, for example, a speaker recognizer is incorporated into a T-F mask estimator that utilizes a DNN, and bottleneck features thereof are utilized in mask estimation. The above operations are described using the following mathematical formula.

$$M ( x ; θ ) = {M}_{2} ( Φ , ψ ; {θ}_{2} ) \qquad ( 3 )$$

$$Φ = {M}_{1} ( x ; {θ}_{1} ) ϵ {R}^{{D}_{m} \times K} \qquad ( 4 )$$

$$Ψ = {Z}_{D} ( x ; {θ}_{z} ) ϵ {R}^{Dz \times K} \qquad ( 5 )$$

$$Z = ( {z}_{1} , … , {z}_{K} ) = W Ψϵ {R}^{H \times K} \qquad ( 6 )$$

$$\begin{matrix}[ Math . 3 ] & \\ \hat{z} = softmax ( \frac{1}{K} {\sum }_{k = 1}^{K} {z}_{k} ) ∈ {R}^{H} & ( 7 )\end{matrix}$$

However, M₁ is a mask estimation feature extraction DNN having a parameter θ₁ and obtains and outputs a feature Φ for generalized mask estimation (for general purpose mask estimation) from the observation signal x. Here, a generalized mask (general purpose mask) refers to a mask that is not specialized to a particular speaker. In other words, the generalized mask is a mask that is common to all speakers. Z_{D} is a speaker recognition feature extraction DNN having a parameter θ_{z} and obtains and outputs a feature ψ for speaker recognition from the observation signal x. M₂ is a mask estimation feature extraction DNN having a parameter θ₂ and estimates and outputs the T-F mask M(x; θ) from the features Φ and ψ. W ϵR^{H×Dz} represents a matrix. softmax represents a softmax function. Dm, Dz, H, and K are positive integers. H represents the number of speakers in an environment in which a training dataset is recorded. 0 represents a set of parameters θ₁, θ₂, and θ_{z} {θ₁, θ₂, θ_{z}}.

The parameters θ₁, θ₂, and θ_{z} are obtained from machine learning using the training dataset of the observation signal x and the target speech signal s. The target speech signal s is provided with information z to identify a speaker who has uttered the target speech signal s. One example of z is a vector in which only the element corresponding to a true speaker (target speaker) who has uttered s is 1 and the other elements are 0 (one-hot-vector).

The observation signal x is input to the mask estimation feature extraction DNN M₁ and the speaker recognition feature extraction DNN Z_{D}, and the mask estimation feature extraction DNN M₁ and the speaker recognition feature extraction DNN Z_{D} obtain and output features Φϵ R^{Dm×K} and ψϵ R^{Dz×K}, respectively (equations (4) and (5)). Φ and ψ are input to the mask estimation feature extraction DNN M₂ (e.g., Φ and ψ are coupled in a feature dimension direction and input to M₂), and the mask estimation feature extraction DNN M₂ obtains and outputs the T-F mask M(x; θ) (equation (3)). At the same time, ψ is multiplied by the matrix W ϵ R^{H×Dz} to obtain Z=(z₁, . . . ,zK) (equation (6)). Further, equation (7) is used to obtain information z\hat{ } to identify an estimated speaker. The type of information to identify the estimated speaker is the same as the type of information to identify the estimated speaker. An example of the information to identify an estimated speaker is a vector in which only the element corresponding to the estimated speaker has 1, and the other elements have 0 (one-hot-vector). In addition, although the suffix “\hat{ }” of z\hat{ } should be marked directly above “z” as in equation (7), it is marked on the upper-right side of “z” due to notation constraints. The parameters θ₁, θ₂, θ_{z} are trained to minimize the multi-task cost function L in which cost functions of speech enhancement and speaker recognition are combined.

L=L^{SDR}+αCrossEntropy(z,z\hat{ }) (8)

Here, α>0 is a mixed parameter, and can be set, for example, to α=1. CrossEntropy (z, z\hat{ }) is a cross-entropy of z and z\hat{ }. The feature ψ represents a speaker recognition bottleneck feature, which is extracted to enhance speech enhancement performance and to determine the speaker. Thus, the feature ψ includes information about the target speaker to enhance speech enhancement performance, and by using this information to estimate the T-F mask M, it is expected to enable specialization to speech enhancement that enhances utterances of the target speaker.

### First Embodiment

Next, a first embodiment of the present disclosure will be described using the drawings.

### Configuration

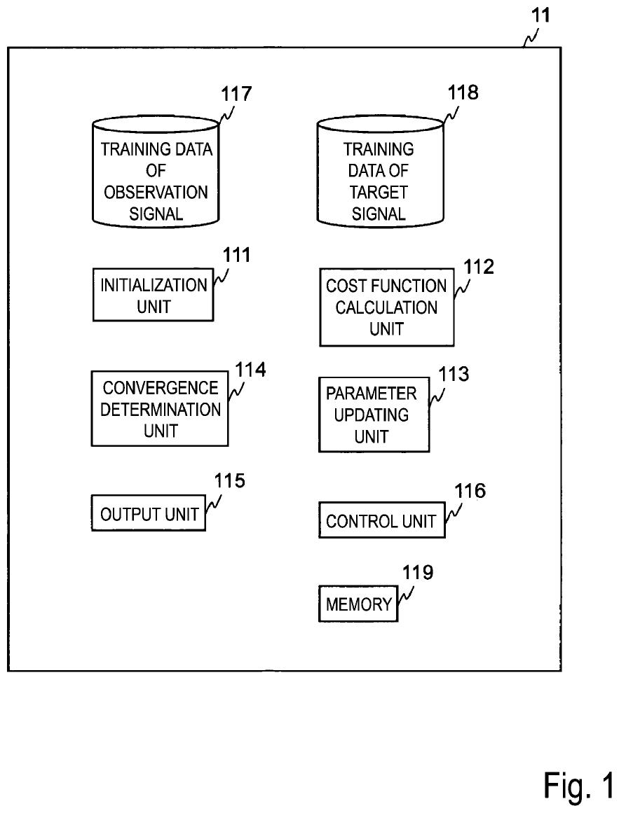

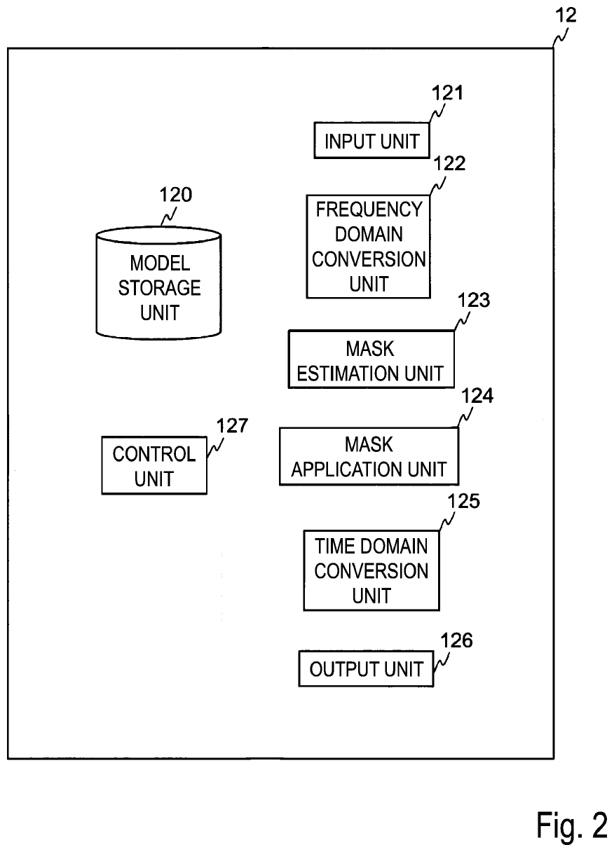

A training apparatus 11 of the present embodiment includes an initialization unit 111, a cost function calculation unit 112, a parameter updating unit 113, a convergence determination unit 114, an output unit 115, a control unit 116, storage units 117 and 118, and a memory 119 as illustrated in FIG. 1. The initialization unit 111, the cost function calculation unit 112, the parameter updating unit 113, and the convergence determination unit 114 correspond to a “training unit”. The speech enhancement apparatus 11 performs each processing under control of the control unit 116. A speech enhancement apparatus 12 of the present embodiment includes a storage unit 120, an input unit 121, a frequency domain conversion unit 122, a mask estimation unit 123, a mask application unit 124, a time domain conversion unit 125, an output unit 126, and a control unit 127 as illustrated in FIG. 2. The speech enhancement apparatus 12 performs each processing under control of the control unit 127.

Training Processing

As a premise of training processing, training data of the observation signal x is stored in the storage unit 117 of the training apparatus 11 (FIG. 1), and training data of the target speech signal s is stored in the storage unit 118. The observation signal x is a time series acoustic signal and is the mixed signal x=s+n of the target speech signal s and a noise signal n. The target speech signal s is also a time series acoustic signal and is a clean speech signal of speech of a target speaker. The target speech signal s is provided with information to identify the target speaker (e.g., a vector in which only the element corresponding to the target speaker has 1 and other elements have 0). The noise signal n is a time series acoustic signal other than the speech signal of which the speech has been uttered by the target speaker.

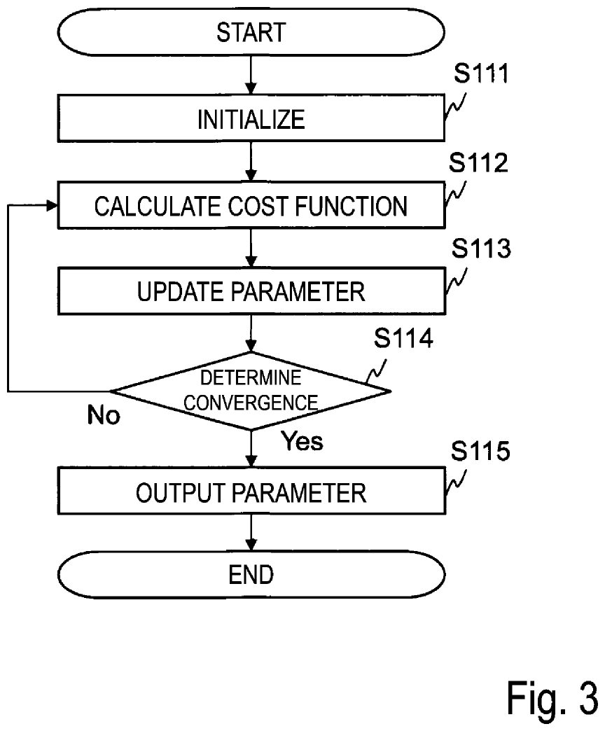

The initialization unit 111 of the training apparatus 11 (FIG. 1) first initializes each of the parameters θ₁, θ₂, and θ_{z} using a pseudo-random number or the like and stores them in the memory 119 in the training processing (step S111) as illustrated in FIG. 3.

Next, the cost function calculation unit 112 receives the training data of the observation signal x extracted from the storage unit 117, the training data of the target speech signal s extracted from the storage unit 118, and the parameters θ₁, θ₂, and θ_{z} extracted from the memory 119 as inputs. The cost function calculation unit 112 calculates and outputs a cost function L shown in equation (8) according to equations (1) to (8), for example (step S112). From equations (2) and (8), the cost function of equation (8) may be transformed as follows.

L=−(clipβ[SDR(s,y)]+clipβ[SDR(n,m)])/2+αCrossEntropy(z,z\hat{ }) (9)

That is, the cost function L is the outcome of addition of the first function (−clipβ[SDR(s, y)]/2), the second function (−clipβ[SDR(n, m)]/2), and the third function (αCrossEntropy(z, z\hat{ })). Here, the first function corresponds to a distance between a speech enhancement signal y corresponding to a post-mask speech signal obtained by applying the T-F mask to the observation signal x and the target speech signal s included in the observation signal x. The second function corresponds to a distance between the noise signal n included in the observation signal x and a residual signal m obtained by excluding the speech enhancement signal y from the observation signal x. The third function corresponds to a distance between the information z\hat{ } to identify an estimated speaker and the information z to identify the speaker who has emitted the target speech signal. Here, a function value of the cost function L becomes smaller as a function value of the first function becomes smaller, a function value of the cost function L becomes smaller as a function value of the second function becomes smaller, and a function value of the cost function L becomes smaller as a function value of the third function becomes smaller.

The cost function L and the parameters θ₁, θ₂, and θ_{z} are input to the parameter updating unit 113. The parameter updating unit 113 updates the parameters θ₁, θ₂, and θ_{z} to minimize the cost function L. For example, the parameter updating unit 113 calculates the gradient for the cost function L and updates the parameters θ₁, θ₂, and θ_{z} to minimize the cost function L using a gradient method. The parameter updating unit 113 updates the parameters θ₁, θ₂, and θ_{z} stored in the memory 119 with the updated parameters θ₁, θ₂, and θ_{z} (step S113). Further, updating the parameters θ₁, θ₂, and θ_{z} is to update a mask estimation feature extraction DNN M₁, the mask estimation feature extraction DNN M₂, and the speaker recognition feature extraction DNN Z_{D}, respectively.

The convergence determination unit 114 determines whether the trained model satisfies convergence conditions of the parameters θ₁, θ₂, and θ_{z}. Examples of the convergence conditions include repeating the processing of steps S112 to S114 a predetermined number of times, or the amount of change of the parameters θ₁, θ₂, θ_{z}, and the cost function L before and after performing the processing of steps S112 to S114 being less than or equal to a predetermined value (step S114).

If it is determined here that the convergence conditions are not met, the processing returns to step S112. On the other hand, if it is determined that the convergence conditions are satisfied, the output unit 115 outputs the parameters θ₁, θ₂, and θ_{z} (step S115). The parameters θ₁, θ₂, and θ_{z} are obtained in step S113 immediately before the convergence determination (step S114) in which it has been determined that the convergence conditions are satisfied, for example. However, instead, the updated parameters θ₁, θ₂, and θ_{z} may be output before the above.

In the above steps S111 through S115, the feature ψ for speaker recognition and the feature Φ for generalized mask estimation are extracted from the observation signal x, the T-F mask is estimated from the feature obtained by combining the feature ψ for speaker recognition and the feature Φ for generalized mask estimation, and the models M₁(x; θ₁), M₂(Φ, ψ; θ₂), and Z_{D}(x; θ_{z}) that obtain information to identify an estimated speaker from the feature ψ for speaker recognition are trained.

Speech Enhancement Processing

Information to identify the models M₁(x; θ₁), M₂(Φ, ψ; θ₂), and Z_{D}(x; θ_{z}) that are trained as described above is stored in the model storage unit 120 of the speech enhancement apparatus 12 (FIG. 2). For example, the parameters θ₁, θ₂, and θ_{z} output from the output unit 115 in step S115 are stored in the model storage unit 120. Under this assumption, the following speech enhancement processing is performed.

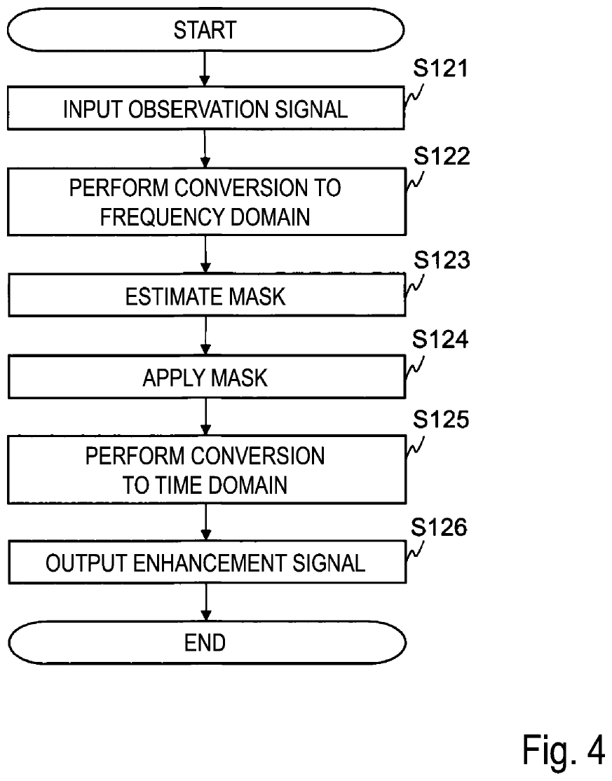

The input unit 121 of the speech enhancement apparatus 12 (FIG. 2) receives the observation signal x which is a time series acoustic signal in the time domain as an input (step S121) as illustrated in FIG. 4.

The observation signal x is input to the frequency domain conversion unit 122. The frequency domain conversion unit 122 obtains and outputs an observation signal X=Q(x) in which the observation signal x is expressed in the time-frequency domain through frequency domain conversion processing Q such as a short-time Fourier transform (step S122).

The observation signal x is input to the mask estimation unit 123. The mask estimation unit 123 estimates and outputs a T-F mask M(x; θ) that enhances speech emitted from the speaker from the observation signal x. Here, the mask estimation unit 123 estimates the T-F mask M(x; θ) from the feature obtained by combining the feature ψ for speaker recognition extracted from the observation signal x and the feature Φ for generalized mask estimation extracted from the observation signal x. This processing is illustrated below. First, the mask estimation unit 123 extracts information (e.g., the parameters θ₁ and θ_{z}) to identify the mask estimation feature extraction DNN M₁ and the speaker recognition feature extraction DNN Z_{D} from the model storage unit 120, inputs the observation signal x into M₁ and Z_{D}, and obtains each of the features Φ and ψ (equations (4), (5)). Next, the mask estimation unit 123 extracts information (e.g., the parameter θ₂) to identify the mask estimation feature extraction DNN M₂ from the model storage unit 120, inputs the features Φ and ψ into the mask estimation feature extraction DNN M₂, and obtains and outputs the T-F mask M(x; θ) (equation (3)) (step S123).

An observation signal X and the T-F mask M(x; θ) are input to the mask application unit 124. The mask application unit 124 applies (or multiplies) the T-F mask M(x; θ) to (or by) the observation signal X in the time-frequency domain, and obtains and outputs the post-mask speech signal M(x; θ)⊚X (step S124).

The post-mask speech signal M(x; θ)⊚X is input to the time domain conversion unit 125. The time domain conversion unit 125 applies time domain conversion processing Q⁺ such as an inverse STFT to the post-mask speech signal M(x; θ)⊚X and obtains and outputs an enhanced speech y in the time domain (equation (1)) (step S126).

### Characteristics of Present Embodiment

In the training processing of the present embodiment described above, the model training apparatus 11 extracts the feature ψ for speaker recognition and the feature Φ for generalized mask estimation from the observation signal x, and estimates the T-F mask from the feature obtained by combining the feature ψ for speaker recognition and the feature Φ for generalized mask estimation, and the models M₁(x; θ₁), M₂(Φ, ψ; θ₂), and Z_{D}(x; θ_{z}) that obtain information to identify an estimated speaker from the feature ψ for speaker recognition are trained. This training is performed to minimize the cost function L that is a sum of the first function (−clipβ[SDR(s, y)]/2) corresponding to the distance between the speech enhancement signal y corresponding to the post-mask speech signal obtained by applying the T-F mask to the observation signal x and the target speech signal s included in the observation signal x, the second function (−clipβ[SDR(n, m)]/2) corresponding to the distance between the noise signal n included in the observation signal x and the residual signal m obtained by excluding the speech enhancement signal y from the observation signal x, and the third function (αCrossEntropy(z, z\hat{ })) corresponding to the distance between the information z\hat{ } to identify an estimated speaker and the information z to identify the speaker who has emitted the target speech signal. In addition, in the speech enhancement processing of the present embodiment, the speech enhancement apparatus 12 estimates the T-F mask M(x; θ) from the feature obtained by combining the feature ψ for speaker recognition extracted from the observation signal x and the feature Φ for generalized mask estimation extracted from the observation signal x, and applies the T-F mask M(x; θ) to the observation signal x to acquire the post-mask speech signal M(x; θ)⊚X. Because the T-F mask M(x; θ) is based on the feature ψ for speaker recognition extracted from the observation signal x and the feature Φ for generalized mask estimation extracted from the observation signal x as described above, it is optimized for the speaker of the observation signal x. In addition, no auxiliary utterance of the target speaker is used for estimation of the T-F mask M(x; θ) in the speech enhancement processing. Thus, in the present embodiment, speech enhancement specialized to a target speaker can be performed without using an auxiliary utterance of the target speaker whose speech is attempted to be enhanced.

Example of Implementation Results of Training and Enhancement

In order to verify the effectiveness of the present embodiment, experiments were performed using a published data set of speech enhancement (NPL 1). For evaluation indexes, perceptual evaluation of speech quality (PESQ), CSIG, CBAK, and COVL which are standard indexes of the data set were used. For comparison methods, SEGAN (NPL 2), MMSE-GAN (NPL 3), DFL (NPL 4), and MetricGAN (NPL 5) were used. These methods are methods that do not utilize speaker information but utilize a large amount of data of speech uttered by a large amount of speakers to train one DNN to train a speaker-independent model. In addition, the accuracy evaluation when the speech enhancement processing was not performed is indicated as Noisy. The results of the experiments are shown in Table 1. The scores of the present embodiment are higher than all of the indexes, which indicates the effectiveness of speech enhancement utilizing multi-task learning of speaker recognition.

TABLE 1

| Method | PESQ | CSIG | CBAK | COVL |
|---|---|---|---|---|
| Noisy | 1.97 | 3.35 | 2.44 | 2.63 |
| SEGAN | 2.16 | 3.48 | 2.94 | 2.80 |
| MMSE-GAN | 2.53 | 3.80 | 3.12 | 3.14 |
| DFL | n/a | 3.86 | 3.33 | 3.22 |
| MetricGAN | 2.86 | 3.99 | 3.18 | 3.42 |
| Present embodiment | 2.96 | 4.13 | 3.44 | 3.54 |

Hardware Configuration

The training apparatus 11 and the speech enhancement apparatus 12 according to the present embodiment are apparatuses configured by a general-purpose or dedicated computer with, for example, a processor (hardware processor) such as a central processing unit (CPU), a memory such as a random access memory (RAM), and read only memory (ROM), and the like executing a predetermined program. The computer may include a single processor or memory, or may include multiple processors and memories. The program may be installed on the computer or may be previously recorded in a ROM or the like. Furthermore, some or all of processing units may be configured using an electronic circuit that implements processing functions alone rather than an electronic circuit (circuitry) such as a CPU that implements a functional configuration by reading a program. Moreover, an electronic circuit constituting one apparatus may include multiple CPUs.

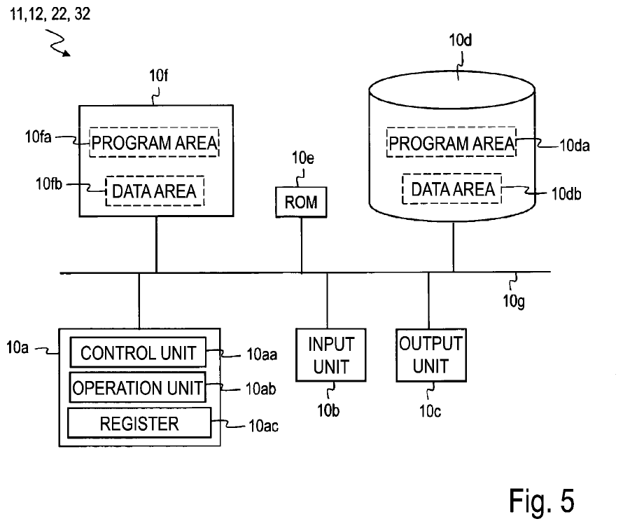

FIG. 5 is a block diagram illustrating a hardware configuration of the training apparatus 11 and the speech enhancement apparatus 12 according to each embodiment. Secure calculation apparatuses 1, 2, and 3 in this example include a central processing unit (CPU) 10a, an output unit 10b, an output unit 10c, a random access memory (RAM) 10d, a read only memory (ROM) 10e, an auxiliary storage device 10f, and a bus 10g as illustrated in FIG. 5. The CPU 10a of this example has a control unit 10aa, an operation unit 10ab, and a register 10ac, and executes various arithmetic processing in accordance with various programs read into the register 10ac. In addition, the output unit 10b is an output terminal, a display, or the like to which data is output. In addition, the output unit 10c is a LAN card or the like that is controlled by the CPU 10a that has read a predetermined program. In addition, the RAM 10d is a static random access memory (SRAM), a dynamic random access memory (DRAM), and the like, and has a program area 10da in which a predetermined program is stored and a data area 10db in which various types of data are stored. In addition, the auxiliary storage device 10f is, for example, a hard disk, an MO (magneto-optical disc), a semiconductor memory, and the like, and includes a program area 10fa in which a predetermined program is stored and a data area 10fb in which various types of data are stored. In addition, the bus 10g connects the CPU 10a, the output unit 10b, the output unit 10c, the RAM 10d, the ROM 10e, and the auxiliary storage device 10f with one another to enable information to be exchanged. The CPU 10a writes a program stored in the program area 10fa of the auxiliary storage device 10f to the program area 10da of the RAM 10d in accordance with a read OS (operating system) program. Similarly, the CPU 10a writes various data stored in the data area 10fa of the auxiliary storage device 10f to the data area 10db of the RAM 10d. Then, the addresses on the RAM 10d to which this program or data has been written are stored in the register 10ac of the CPU 10a. The control unit 10ab of the CPU 10a sequentially reads these addresses stored in the register 10ac, reads the program and data from the area on the RAM 10d indicated by the read addresses, causes the operation unit 10ab to perform operations indicated by the program, and stores the calculation results in the register 10ac. With such a configuration, the functional configurations of the training apparatus 11 and the speech enhancement apparatus 12 are implemented.

The above-described program can be recorded on a computer-readable recording medium. An example of the computer-readable recording medium is a non-transitory recording medium. Examples of such a recording medium include a magnetic recording device, an optical disc, a magneto-optical recording medium, or a semiconductor memory.

The program is distributed, for example, by selling, transferring, or lending a portable recording medium such as a DVD or a CD-ROM with the program recorded on it. Further, the program may be distributed by storing the program in a storage device of a server computer and forwarding the program from the server computer to another computer via a network. For example, a computer that executes such a program first temporarily stores the program recorded on the portable recording medium or the program forwarded from the server computer in its own storage device. When executing the processing, the computer reads the program stored in its own storage device and executes the processing in accordance with the read program. Further, as another execution form of this program, the computer may directly read the program from the portable recording medium and execute processing in accordance with the program, or, further, may sequentially execute the processing in accordance with the received program each time the program is forwarded from the server computer to the computer. In addition, the above-described processing may be executed through a so-called application service provider (ASP) service in which processing functions are implemented just with issuing an instruction to execute the program and obtaining results without forwarding the program from the server computer to the computer. Further, the program in this embodiment is assumed to include information which is provided for processing of a computer and is equivalent to a program (data or the like with characteristics of regulating processing of the computer, rather than a direct command to the computer).

In each embodiment, although the present apparatus is configured by executing a predetermined program on a computer, at least a part of the processing details may be implemented by hardware.

### Other Modified Examples

Here, the present disclosure is not limited to the above-described embodiment. For example, in the embodiment described above, the observation signal x in the time domain is input to the speech enhancement apparatus 12, and the frequency domain conversion unit 122 converts the observation signal x into the observation signal X=Q(x) that is expressed in the time-frequency domain. However, the observation signal x and the observation signal X may be input to the speech enhancement apparatus 12. In this case, the frequency domain conversion unit 122 may be omitted from the speech enhancement apparatus 12.

In the embodiment described above, the speech enhancement apparatus 12 applies the time domain conversion process Q⁺ to the post-mask speech signal M(x; θ)⊚X in the time-frequency domain to obtain and output the enhanced speech y in the time domain. However, the speech enhancement apparatus 12 may output the post-mask speech signal M(x; θ)⊚X as it is. In this case, the post-mask speech signal M(x; θ)⊚X may be used as an input in other processing. In this case, the time domain conversion unit 125 may be omitted from the speech enhancement apparatus 12.

Although DNNs are used as the models M₁, M₂, and Z_{D} in the embodiments described above, other models, such as a probability model, may be used as the models M₁, M₂, and Z_{D}. The models M₁, M₂, and Z_{D} may be configured as one or two models.

In the embodiments described above, speech emitted from a desired speaker is enhanced. However, it may be speech enhancement processing that enhances speech emitted from a desired sound source. In this case, the processing may be performed by replacing the “speaker” described above with a “sound source”.

In addition, the various processing described above may be executed not only in chronological order as described but also in parallel or individually as necessary or depending on the processing capabilities of the apparatuses that execute the processing. Further, it is needless to say that the present disclosure can appropriately be modified without departing from the gist of the present disclosure.

### REFERENCE SIGNS LIST

11 Training apparatus
12 Speech enhancement apparatus

1. A speech enhancement method for enhancing speech, the speech enhancement method comprising:
estimating, from an observation signal, a mask to enhance speech emitted from a speaker;
applying the mask to the observation signal to obtain a post-mask speech signal,
wherein the estimating the mask further comprises
estimating the mask from a feature obtained by combining a feature for speaker recognition extracted from the observation signal and a feature for generalized mask estimation extracted from the observation signal; and
outputting the post-mask speech signal as an enhanced speech of the speaker.

2. (canceled)

3. A training method comprising:
extracting, from an observation signal, a feature for speaker recognition and a feature for generalized mask estimation to estimate a mask from a feature obtained by combining the feature for speaker recognition and the feature for generalized mask estimation and train a model that obtains information to identify an estimated speaker from the feature for speaker recognition,
wherein the model is trained to minimize a cost function that is a sum of a first function corresponding to a distance between a speech enhancement signal corresponding to a post-mask speech signal obtained by applying the mask to the observation signal and a target speech signal included in the observation signal, a second function corresponding to a distance between a noise signal included in the observation signal and a residual signal obtained by excluding the speech enhancement signal from the observation signal, and a third function corresponding to a distance between information to identify the estimated speaker and information to identify a speaker who emits the target speech signal, and a function value of the cost function becomes smaller as a function value of the first function becomes smaller, the function value of the cost function becomes smaller as a function value of the second function becomes smaller, and the function value of the cost function becomes smaller as a function value of the third function becomes smaller; and
causing generation of the post-mask speech of the target speaker as an enhanced speech of the target speaker using the estimated mask.

4. (canceled)

5. A speech enhancement apparatus configured to enhance speech emitted from a speaker that is desired, the speech enhancement apparatus comprising a processor configured to execute a method comprising:
estimating, from an observation signal, a mask to enhance speech emitted from the speaker;
generating, based on the mask and the observation signal, a post-mask speech signal,
wherein the generating the post-mask speech signal further comprises estimation of the mask from a feature obtained by combining a feature for speaker recognition extracted from the observation signal and a feature for generalized mask estimation extracted from the observation signal; and
outputting the post-mask speech signal as an enhanced speech of the speaker.

6-8. (canceled)

9. The speech enhancement method according to claim 1, wherein the speaker includes a sound source.

10. The speech enhancement method according to claim 1, the method further comprising:
extracting, from a training observation signal, a feature for speaker recognition and a feature for generalized mask estimation to estimate the mask from a feature obtained by combining the feature for speaker recognition and the feature for generalized mask estimation and train the model that obtains information to identify an estimated speaker from the feature for speaker recognition,
wherein the model is trained to minimize a cost function that is a sum of
a first function corresponding to a distance between a speech enhancement signal corresponding to a post-mask speech signal obtained by applying the mask to the observation signal and a target speech signal included in the observation signal,
a second function corresponding to a distance between a noise signal included in the observation signal and a residual signal obtained by excluding the speech enhancement signal from the observation signal, and
a third function corresponding to a distance between information to identify the estimated speaker and information to identify a speaker who emits the target speech signal, and
a function value of the cost function becomes smaller as a function value of the first function becomes smaller, the function value of the cost function becomes smaller as a function value of the second function becomes smaller, and the function value of the cost function becomes smaller as a function value of the third function becomes smaller.

11. The speech enhancement method according to claim 10, wherein the noise signal includes a time series acoustic signal other than the speech signal of which the speech has been uttered by the target speaker.

12. The speech enhancement method according to claim 10, wherein the model is trained without using an auxiliary utterance of the target speaker whose speech is attempted to be enhanced.

13. The training method according to claim 3, wherein the speaker includes a sound source.

14. The training method according to claim 3, therein the noise signal includes a time series acoustic signal other than the speech signal of which the speech has been uttered by the target speaker.

15. The speech enhancement apparatus according to claim 5, wherein the speaker includes a sound source.

16. The speech enhancement apparatus according to claim 5, the processor further configured to execute a method comprising:
extracting, from a training observation signal, a feature for speaker recognition and a feature for generalized mask estimation to estimate the mask from a feature obtained by combining the feature for speaker recognition and the feature for generalized mask estimation and train the model that obtains information to identify an estimated speaker from the feature for speaker recognition,
wherein the model is trained to minimize a cost function that is a sum of
a first function corresponding to a distance between a speech enhancement signal corresponding to a post-mask speech signal obtained by applying the mask to the observation signal and a target speech signal included in the observation signal,
a second function corresponding to a distance between a noise signal included in the observation signal and a residual signal obtained by excluding the speech enhancement signal from the observation signal, and
a third function corresponding to a distance between information to identify the estimated speaker and information to identify a speaker who emits the target speech signal, and
a function value of the cost function becomes smaller as a function value of the first function becomes smaller, the function value of the cost function becomes smaller as a function value of the second function becomes smaller, and the function value of the cost function becomes smaller as a function value of the third function becomes smaller.

17. The speech enhancement apparatus according to claim 16, wherein the noise signal includes a time series acoustic signal other than the speech signal of which the speech has been uttered by the target speaker.

18. The speech enhancement apparatus according to claim 16, wherein the model is trained without using an auxiliary utterance of the target speaker whose speech is attempted to be enhanced.
